(19) United States
(12) Patent Application Publication
(10) Pub. No.: US 2017/0291411 A1
(43) Pub. Date: Oct. 12, 2017

(54) INKJET HEAD AND INKJET PRINTER

(71) Applicant: TOSHIBA TEC KABUSHIKI KAISHA, Tokyo (JP)

(72) Inventor: Sota Harada, Sunto (JP)

(21) Appl. No.: 15/379,675

(22) Filed: Dec. 15, 2016

(30) Foreign Application Priority Data
Apr. 7, 2016 (JP) 2016-077288

(51) Int. Cl. B41J 2/045

(52) U.S. Cl. CPC B41J 2/04541; B41J 2/04581

(57) ABSTRACT

In accordance with an embodiment, an inkjet head comprises a first actuator and a second actuator, a first electrode, a second electrode, a third electrode, and a drive controller. The first actuator and the second actuator constitute a pressure chamber. The first electrode comes in contact with the first actuator from the outer side of the pressure chamber. The second electrode comes in contact with the first actuator and the second actuator from the inner side of the pressure chamber. The third electrode comes in contact with the second actuator from the outer side of the pressure chamber. The drive control section outputs an auxiliary pulse which generates volume change in the pressure chamber that is smaller than volume change of the pressure chamber generated by an ejection pulse for ejecting ink from the pressure chamber to the first electrode, the second electrode, and the third electrode.

### CROSS-REFERENCE TO RELATED APPLICATIONS

This application is based upon and claims the benefit of priority from Japanese Patent Application No. P2016-077288, filed Apr. 7, 2016, the entire contents of which are incorporated herein by reference.

### FIELD

Embodiments described herein relate generally to an inkjet head and an inkjet printer and methods related thereto.

### BACKGROUND

An inkjet head is provided with a pressure chamber for filling ink and an actuator for generating pressure vibration in the pressure chamber. In the inkjet head, an auxiliary pulse for not ejecting ink is applied to the actuator before and after ink is ejected from the pressure chamber, and reduction in print quality is prevented as a result.

However, if the inkjet head applies the auxiliary pulse to the actuator, there are times when the volume amount of the ink chamber changes and becomes excessively large. If the change in the volume becomes excessively large, it becomes difficult for the inkjet head to adjust the pressure vibration in the ink chamber.

### DESCRIPTION OF THE DRAWINGS

FIG. 1 is a diagram illustrating an example of the configuration of an inkjet printer according to a first embodiment;

FIG. 2 is a diagram illustrating an example of a cross-sectional view of an inkjet head according to the first embodiment;

FIG. 3 is a diagram illustrating an example of the configuration of a drive control section of the inkjet head according to the first embodiment;

FIG. 4 is a diagram illustrating an example of a voltage waveform applied to an electrode according to the first embodiment;

FIG. 5 is a cross-sectional view illustrating an example of operations of the inkjet head according to the first embodiment;

FIG. 6 is a diagram illustrating an example of a voltage waveform applied to an electrode according to a second embodiment;

FIG. 7 is a cross-sectional view illustrating an example of operations of the inkjet head according to the second embodiment;

FIG. 8 is a diagram illustrating an example of a voltage waveform applied to an electrode according to a third embodiment; and

FIG. 9 is a cross-sectional view illustrating an example of operations of an inkjet head according to the third embodiment.

### DETAILED DESCRIPTION

In accordance with an embodiment, an inkjet head comprises a first actuator and a second actuator, a first electrode, a second electrode, a third electrode, and a drive control section or drive controller. The first actuator and the second actuator constitute a pressure chamber. The first electrode comes in contact with the first actuator from the outer side of the pressure chamber. The second electrode comes in contact with the first actuator and the second actuator from the inner side of the pressure chamber. The third electrode comes in contact with the second actuator from the outer side of the pressure chamber. The drive control section outputs an auxiliary pulse which generates volume change in the pressure chamber that is smaller than volume change of the pressure chamber generated by an ejection pulse for ejecting ink from the pressure chamber to the first electrode, the second electrode and the third electrode.

In accordance with another embodiment, a printer contains the inkjet head as described herein.

In accordance with yet another embodiment, an inkjet printing method involves contacting a first actuator from an outer side of a pressure chamber; contacting the first actuator and a second actuator from an inner side of the pressure chamber; contacting the second actuator from the outer side of the pressure chamber; and outputting an auxiliary pulse which generates a volume change in the pressure chamber that is smaller than a volume change of the pressure chamber generated by an ejection pulse for ejecting ink from the pressure chamber to a first electrode, a second electrode, and a third electrode.

Hereinafter, an embodiment is described with reference to the accompanying drawings.

### First Embodiment

An inkjet printer according to the embodiment ejects ink stored in an ink cartridge to a medium (for example, a paper) and forms an image on the medium.

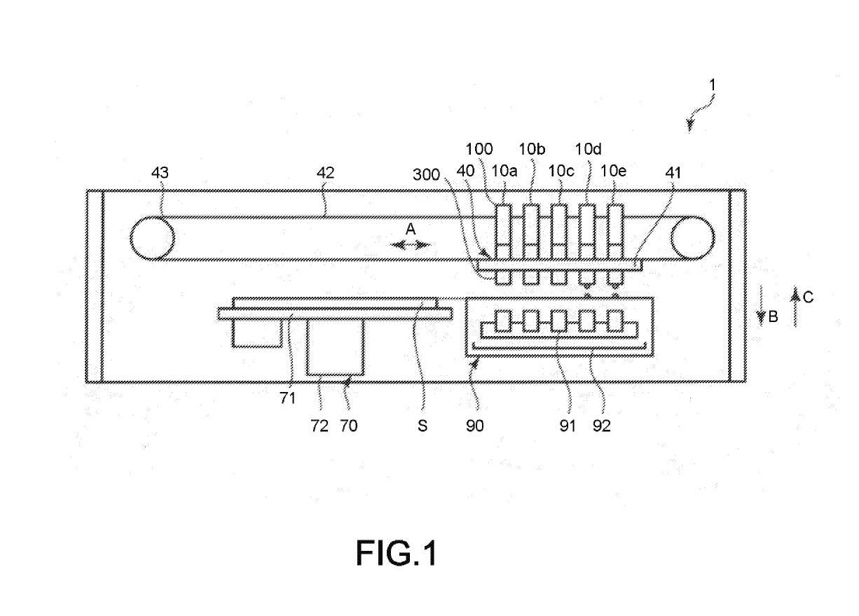

FIG. 1 is a diagram illustrating an example of the configuration of an inkjet printer 1.

The inkjet printer 1 is provided with a plurality of inkjet head units 10(10a to 10e) and ink cartridges respectively corresponding to the plurality of the inkjet head units 10. Further, the inkjet printer 1 is provided with a head support section 40, a medium moving section 70 (conveyance section) and a maintenance unit 90. The head support section 40 movably supports the plurality of the inkjet head units 10. The medium moving section 70 movably supports a medium S. The number of the inkjet head units 10 included in the inkjet printer 1 is not limited to a specific number.

The inkjet head unit 10 is provided with an inkjet head 300 serving as a liquid ejection section and an ink circulation device 100 for circulating ink.

In a case in which the inkjet printer 1 is a color printer, the ink cartridge of each color respectively communicates with the ink circulation device 100 of the corresponding inkjet head unit 10 via a tube. Each ink cartridge supplies the ink to each inkjet head unit 10.

The colors of the ink of the inkjet head units 10 may be different from each other. In the color inkjet printer 1, for example, the color of the ink is cyan, magenta, yellow or black.

The head support section 40 conveys and fixes the inkjet head unit 10 to a predetermined position. For example, the head support section 40 is provided with a carriage 41, a conveyance belt 42 and a carriage motor 43. The carriage 41 supports the plurality of the inkjet head units 10. The conveyance belt 42 enables the carriage 41 to reciprocate in an arrow A direction. The carriage motor 43 drives the conveyance belt.

The medium moving section 70 conveys the medium S on a predetermined conveyance route. For example, the medium moving section 70 is provided with a table 71 for absorbing and fixing the medium S. The table 71 is mounted at the upper part of a slide rail device 72, and reciprocates in a direction orthogonal to an arrow A and an arrow B (in a direction orthogonal to the surface of FIG. 1). In other words, the medium moving section 70 enables the table 71 to reciprocate in a direction orthogonal to the carriage 41.

The maintenance unit 90 is a scan range of the plurality of the inkjet head units 10 in the arrow A direction, and is arranged at a position to the outer side of a moving range of the table 71. The maintenance unit 90 is a case body with the upper part opened, and is movably arranged in the vertical direction (in arrows B and C directions in FIG. 1).

The maintenance unit 90 is provided with a blade 91 made of rubber and a waste ink reception section 92. The blade 91 removes ink, dirt or paper dust adhering to a nozzle plate of the inkjet head 300 of the inkjet head unit 10 of each color. The waste ink reception section 92 receives the ink, dirt or paper dust removed by the blade 91. The maintenance unit 90 is provided with a mechanism for moving the blade 91 to the direction orthogonal to the arrow A and the arrow B. The blade 91 wipes the surface of the nozzle plate.

Next, an example of the configuration of the inkjet head 300 is described.

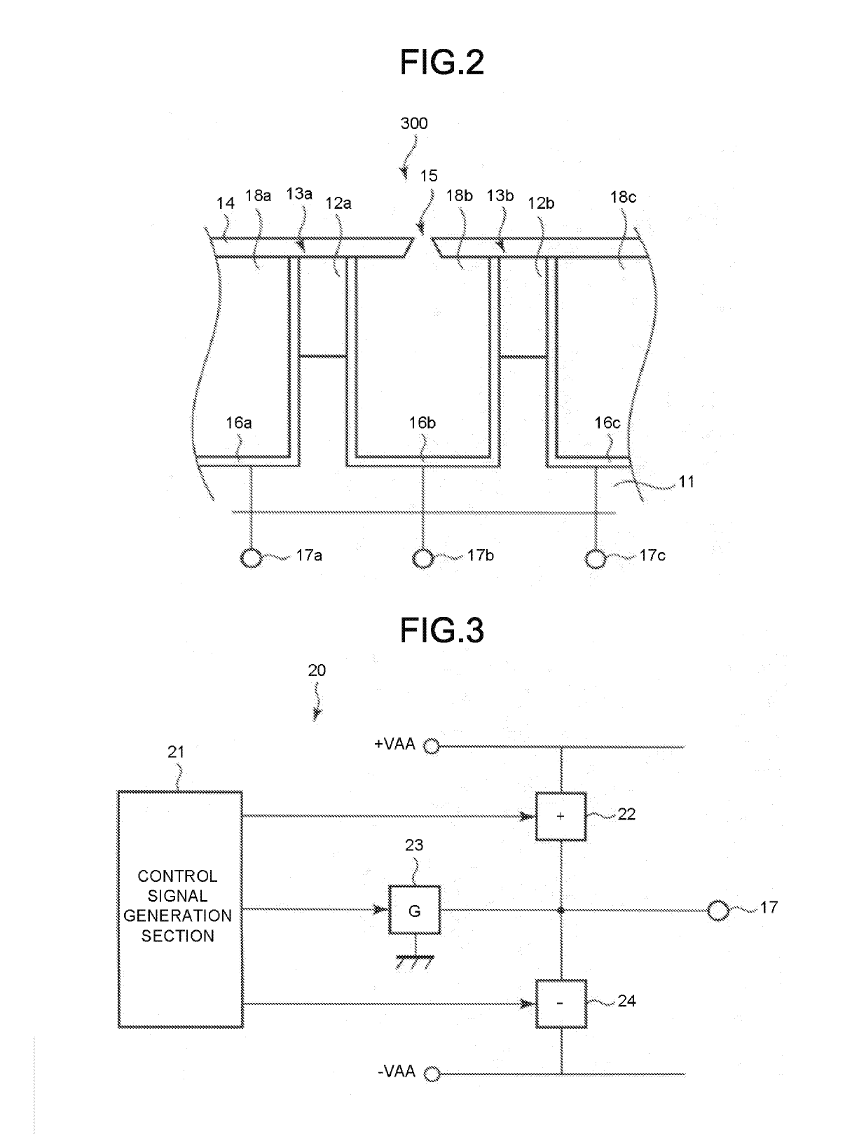

FIG. 2 illustrates an example of a cross-sectional view of the inkjet head 300.

The inkjet head 300 is a share mode-type inkjet head of end chute type. Furthermore, the inkjet head 300 is not limited to the share mode-type inkjet head of end chute type. The inkjet head 300 ejects the ink to the medium which is supplied by the medium moving section 70.

As shown in FIG. 2, the inkjet head 300 is provided with a first piezoelectric element 11, second piezoelectric elements 12a and 12b, a nozzle plate 14, electrodes 16a to 16c, leads 17a to 17c and a drive control section 20 which is described later. The inkjet head 300 may be further provided with, for example, a cover and a tube connected with the ink cartridge.

The inkjet head 300 has a structure in which the first piezoelectric element 11 is jointed with the surface of a base substrate which is not shown and the second piezoelectric element 12 is jointed with the top of the first piezoelectric element 11. Polarization directions of the first piezoelectric element 11 and the second piezoelectric element 12 are opposite to each other. A large number of long grooves are arranged from one end of the first piezoelectric element 11 and the second piezoelectric element 12 to the other end. The grooves are parallel to each other at a predetermined interval.

The first piezoelectric element 11 and the second piezoelectric element 12 are formed by, for example, lead zirconate titanate (PZT).

The first piezoelectric element 11 and the second piezoelectric element 12a form an actuator 13a (first actuator). Similarly, the first piezoelectric element 11 and the second piezoelectric element 12b form an actuator 13b (second actuator).

The nozzle plate 14 is formed on the second piezoelectric element 12. The nozzle plate 14 is provided with an opening 15. The actuators 13a and 13b and the nozzle plate 14 form a pressure chamber 18b inside. The opening 15 communicates with the pressure chamber 18b. Pressure chambers 18a and 18c are adjacent to the pressure chamber 18b, and formed respectively at the actuators 13a and 13b side.

The pressure chamber 18 is provided with a supply port for receiving supply of ink from an ink tank in order to fill ink. Further, the pressure chamber 18 is provided with an ejection port for ejecting the ink.

The electrodes 16a to 16c are formed in such a way as to respectively contact with side walls and bottoms of the pressure chambers 18a to 18c. In other words, the electrodes 16a to 16c respectively cover inner faces of the pressure chambers 18a to 18c.

The electrode 16a (first electrode) comes in contact with the actuator 13a from the outer side of the pressure chamber 18b. Further, the electrode 16b (second electrode) comes in contact with the actuators 13a and 13b from the inner side of the pressure chamber 18b. Further, the electrode 16c (third electrode) comes in contact with the actuator 13b from the outer side of the pressure chamber 18b.

The actuator 13a is formed between the electrode 16a and the electrode 16b. In other words, if voltages are applied to the electrode 16a and the electrode 16b, a difference between both voltages is applied to the actuator 13a.

Similarly, the actuator 13b is formed between the electrode 16b and the electrode 16c. In other words, if voltages are applied to the electrode 16b and the electrode 16c, a difference between both voltages is applied to the actuator 13b.

The leads 17a to 17c are extended respectively from the electrodes 16a to 16c to an external device. The leads 17a to 17c are connected with the drive control section 20. In other words, the drive control section 20 can apply drive voltages to the electrodes 16a to 16c by applying the drive voltages to the leads 17a to 17c.

Next, the drive control section 20 of the inkjet head 300 is described.

FIG. 3 is a diagram illustrating an example of the configuration of the drive control section 20.

The drive control section 20 outputs the drive voltage to the electrode 16. For example, the drive control section 20 outputs an expansion pulse D for expanding the volume of the pressure chamber 18 and a contraction pulse P for contracting the volume of the pressure chamber 18 as the drive voltage. Further, the drive control section 20 arranges quiescent time R between the expansion pulse D and the contraction pulse P. Further, the drive control section 20 outputs an auxiliary pulse before the expansion pulse D and after the contraction pulse P. The auxiliary pulse is described later.

As shown in FIG. 3, the drive control section 20 is provided with a control signal generation section 21 and transistors 22 to 24.

The control signal generation section 21 generates a waveform pattern of the drive voltage for ejecting the ink. The waveform pattern is composed of an expansion pulse pattern, a contraction pulse pattern and the quiescent time. The expansion pulse pattern forms the expansion pulse D for expanding the volume of the pressure chamber 18 at a predetermined time. The contraction pulse pattern forms the contraction pulse P for contracting the volume of the pressure chamber 18 at a predetermined time. The quiescent time is time between the expansion pulse and the contraction pulse. Polarities of the expansion pulse pattern and the contraction pulse pattern are reverse. A sum of the time of the expansion pulse pattern, the quiescent time and the time of the contraction pulse pattern is a section for ejecting an ink droplet of one drop, that is, one drop period. In other words, the ejection pulse for ejecting one drop is composed of the expansion pulse, the quiescent time R and the contraction pulse P.

Further, the control signal generation section 21 generates a pattern of the drive voltage (drive voltage pattern) applied to the electrode 16 on the basis of the waveform pattern and print data input from a bus line.

The control signal generation section 21 generates a control signal for controlling the transistors 22 to 24 on the basis of the drive voltage pattern. The control signal generation section 21 outputs the control signal to the transistors 22 to 24.

The transistor 22 is connected with the lead 17 and a voltage +VAA. The transistor 23 is connected with the lead 17 and a GND. The transistor 24 is connected with the lead 17 and a voltage −VAA.

The transistor 22 connects a source with the voltage +VAA, connects a drain with the lead 17, and connects a gate with the control signal generation section 21. If the transistor 22 is turned on the basis of the control signal from the control signal generation section 21, the lead 17 and the voltage +VAA are connected. As a result, the lead 17 becomes the voltage +VAA. Further, if the transistor 22 is turned off on the basis of the control signal from the control signal generation section 21, the lead 17 becomes a high impedance.

The transistor 23 connects the source with the GND, connects the drain with the electrode, and connects the gate with the control signal generation section 21. If the transistor 23 is turned on on the basis of the control signal from the control signal generation section 21, the lead 17 and the GND are connected. As a result, the lead 17 becomes the GND. Further, if the transistor 23 is turned off on the basis of the control signal from the control signal generation section 21, the lead 17 becomes the high impedance.

The transistor 24 connects the source with the voltage −VAA, connects the drain with the electrode, and connects the gate with the control signal generation section 21. If the transistor 24 is turned on on the basis of the control signal from the control signal generation section 21, the lead 17 and the voltage −VAA are connected. As a result, the lead 17 becomes the voltage −VAA. Further, If the transistor 24 is turned off on the basis of the control signal from the control signal generation section 21, the lead 17 becomes the high impedance.

The control signal generation section 21 performs such control that the transistors 22 to 24 are not turned on simultaneously, and controls whether any one of the transistors 22 to 24 is turned on or all of the transistors 22 to 24 are turned off.

The drive control section 20 is provided with the transistors 22 to 24 for each pressure chamber 18. The control signal generation section 21 outputs the control signal corresponding to each pressure chamber 18 to the transistors 22 to 24 corresponding to each pressure chamber 18.

For example, the drive control section 20 outputs the expansion pulse D as follows. The pressure chamber 18b is described as an example.

The drive control section 20 outputs a driving signal for drive in a direction in which the volume of the pressure chamber 18b is expanded to the actuators 13a and 13b as the expansion pulse D. For example, the drive control section 20 applies the voltage +VAA to the lead 17a and the lead 17c, and applies the voltage −VAA to the lead 17b. The actuator 13a in a state in which the voltage +VAA is applied to the lead 17a and the voltage −VAA is applied to the lead 17b is applied with a voltage of +VAA*2 based on the electrode 16b. The actuator 13a to which the voltage of +VAA*2 is applied is driven to the outer side (in a direction in which the volume of the pressure chamber 18b is expanded).

The actuator 13b in a state in which the voltage +VAA is applied to the lead 17c and the voltage −VAA is applied to the lead 17b is applied with the voltage of +VAA*2 based on the electrode 16b. The actuator 13b to which the voltage of +VAA*2 is applied is driven to the outer side (in a direction in which the volume of the pressure chamber 18b is expanded).

Further, the drive control section 20 outputs the contraction pulse P as follows. The drive control section 20 outputs a driving signal for drive in a direction in which the volume of the pressure chamber 18b is contracted to the actuators 13a and 13b as the contraction pulse P. For example, the drive control section 20 applies the voltage −VAA to the lead 17a and the lead 17c, and applies the voltage +VAA to the lead 17b. The actuator 13a in a state in which the voltage −VAA is applied to the lead 17a and the voltage +VAA is applied to the lead 17b is applied with a voltage of −VAA*2 based on the electrode 16b. The actuator 13a to which the voltage of −VAA*2 is applied is driven to the inner side (in a direction in which the volume of the pressure chamber 18b is contracted).

The actuator 13b in a state in which the voltage −VAA is applied to the lead 17c and the voltage +VAA is applied to the lead 17b is applied with the voltage of −VAA*2 based on the electrode 16b. The actuator 13b to which the voltage of −VAA*2 is applied is driven to the inner side (in a direction in which the volume of the pressure chamber 18b is contracted).

Next, the auxiliary pulse output by the drive control section 20 is described.

The auxiliary pulse generates the pressure vibration in the pressure chamber 18 in order to prevent reduction in print quality. The auxiliary pulse generates volume change to such an extent that the ink is not ejected in the pressure chamber 18.

The auxiliary pulse generates the volume change in the pressure chamber 18 which is smaller than volume change of the pressure chamber 18 generated by the expansion pulse or the contraction pulse. For example, the auxiliary pulse drives one of the actuators 13 which form the pressure chamber 18. Herein, the auxiliary pulse drives the actuator 13b but not the actuator 13a.

The auxiliary pulse is composed of an auxiliary expansion pulse Dmp for expanding the volume of the pressure chamber 18 and an auxiliary contraction pulse Bst for contracting the volume of the pressure chamber 18.

The auxiliary expansion pulse Dmp generates a change amount in the pressure chamber 18 which is smaller than a change amount of expansion of the volume of the pressure chamber 18 due to the expansion pulse. For example, the auxiliary expansion pulse Dmp generates a change amount which is about 50% of a change amount generated due to the expansion pulse.

For example, the auxiliary expansion pulse Dmp drives the one actuator 13 in a direction in which the volume of the pressure chamber 18 is expanded. For example, the drive control section 20 applies the drive voltage to the actuator 13b without applying the drive voltage to the actuator 13a as the auxiliary expansion pulse Dmp.

For example, the drive control section 20 applies the voltage −VAA (first drive voltage) to the lead 17a and the lead 17b, and applies the voltage +VAA (second drive voltage obtained by reversing the first drive voltage) to the lead 17c. The actuator 13a in a stated in which the voltage −VAA is applied the leads 17a and 17b is not driven without being applied with the voltage.

The actuator 13b in a stated in which the voltage −VAA is applied to the lead 17b and the voltage +VAA is applied to the lead 17c is applied with the voltage of +VAA*2 based on the electrode 16b. The actuator 13b to which the voltage of +VAA*2 is applied is driven to the outer side (in a direction in which the volume of the pressure chamber 18b is expanded). If the actuator 13b is driven to the outer side, the volume of the pressure chamber 18b is increased by about 50% of the increase of the volume generated due to the expansion pulse D.

Further, the auxiliary contraction pulse Bst generates a change amount in the pressure chamber 18 which is smaller than a change amount of contraction of the volume of the pressure chamber 18 due to the contraction pulse. For example, the auxiliary contraction pulse Bst generates a change amount which is about 50% or more of a change amount generated due to the contraction pulse.

The auxiliary contraction pulse Bst drives the one actuator 13 in a direction in which the volume of the pressure chamber 18 is contracted. For example, the drive control section 20 applies the drive voltage to the actuator 13b without applying the drive voltage to the actuator 13a as the auxiliary contraction pulse Bst.

For example, the drive control section 20 applies the voltage +VAA (first drive voltage) to the lead 17a and the lead 17b, and applies the voltage −VAA (second drive voltage obtained by reversing the first drive voltage) to the lead 17c. The actuator 13a in a state in which the voltage +VAA is applied to the leads 17a and 17b is not driven without being applied with the voltage.

The actuator 13b in a state in which the voltage +VAA is applied to the lead 17b and the voltage −VAA is applied to the lead 17c is applied with the voltage of −VAA*2 based on the electrode 16b. The actuator 13b to which the voltage of −VAA*2 is applied is driven to the inner side (in a direction in which the volume of the pressure chamber 18b is contracted). If the actuator 13b is driven to the inner side, the volume of the pressure chamber 18b is decreased by about 50% or more due to the contraction pulse P.

Next, the drive voltages which are applied to the leads 17a to 17c by the drive control section 20 are described.

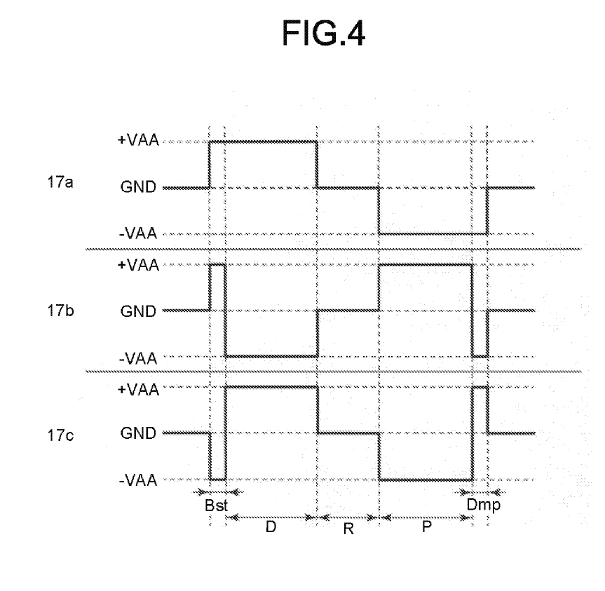

FIG. 4 is a timing chart illustrates the drive voltages which are applied to the leads 17a to 17c by the drive control section 20.

The drive control section 20 outputs the auxiliary pulse before and after the ejection pulse is output. Herein, the drive control section 20 outputs the auxiliary contraction pulse Bst, the ejection pulse and the auxiliary expansion pulse Dmp in order.

As shown in FIG. 4, the drive control section 20 outputs the auxiliary contraction pulse Bst, the expansion pulse D, the contraction pulse P and the auxiliary expansion pulse Dmp to the leads 17a to 17c in order. Further, the drive control section 20 arranges the quiescent time R between the expansion pulse D and the contraction pulse P.

The drive control section 20 applies the voltage +VAA to the lead 17a as the auxiliary contraction pulse Bst. The drive control section 20 applies the voltage +VAA as the expansion pulse D if outputting the auxiliary contraction pulse Bst. The drive control section 20 waits for the quiescent time R if outputting the expansion pulse D. The drive control section 20 applies the voltage −VAA as the contraction pulse P if waiting for the quiescent time R. The drive control section 20 applies the voltage −VAA as the auxiliary expansion pulse Dmp if outputting the contraction pulse P.

Further, the drive control section 20 applies the voltage +VAA to the lead 17b as the auxiliary contraction pulse Bst. The drive control section 20 applies the voltage −VAA as the expansion pulse D if outputting the auxiliary contraction pulse Bst. The drive control section 20 waits for the quiescent time R if outputting the expansion pulse D. The drive control section 20 applies the voltage +VAA as the contraction pulse P if waiting for the quiescent time R. The drive control section 20 applies the voltage −VAA as the auxiliary expansion pulse Dmp if outputting the contraction pulse P.

Further, the drive control section 20 applies the voltage −VAA to the lead 17c as the auxiliary contraction pulse Bst. The drive control section 20 applies the voltage +VAA as the expansion pulse D if outputting the auxiliary contraction pulse Bst. The drive control section 20 waits for the quiescent time R if outputting the expansion pulse D. The drive control section 20 applies the voltage −VAA as the contraction pulse P if waiting for the quiescent time R. The drive control section 20 applies the voltage +VAA as the auxiliary expansion pulse Dmp if outputting the contraction pulse P.

Next, an example of operations of the actuators 13a and 13b is described.

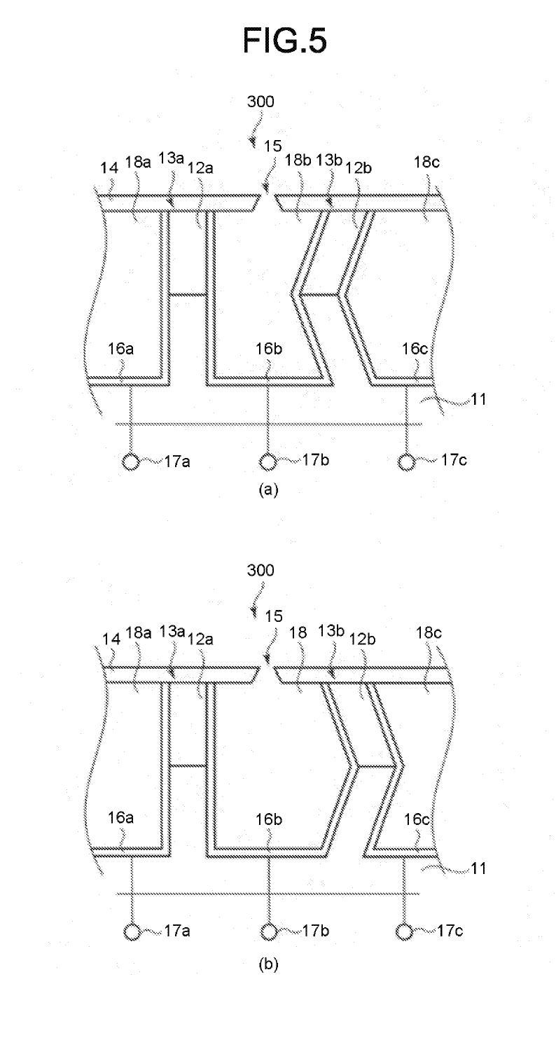

FIG. 5 is a diagram illustrating an example of the operations of the actuators 13a and 13b while the drive control section 20 outputs the auxiliary pulse. FIG. 5(a) illustrates an example of the operations while the drive control section 20 outputs the auxiliary contraction pulse Bst. Further, FIG. 5(b) illustrates an example of the operations while the drive control section 20 outputs the auxiliary expansion pulse Dmp.

The drive control section 20 applies the voltage +VAA to the leads 17a and 17b as the auxiliary contraction pulse Bst. If the voltage +VAA is applied to the leads 17a and 17b, the actuator 13a is not driven without being applied with the drive voltage as shown in FIG. 5(a).

Further, the drive control section 20 applies the voltage −VAA to the lead 17c as the auxiliary contraction pulse Bst. If the voltage −VAA is applied to the lead 17c, the actuator 13b is applied with the drive voltage of −VAA*2 based on the electrode 16b. The actuator 13b to which the drive voltage of −VAA*2 is applied is driven to be bent to the inner side of the pressure chamber 18b as shown in FIG. 5(a).

Further, the drive control section 20 applies the voltage −VAA to the leads 17a and 17b as the auxiliary expansion pulse Dmp. If the voltage −VAA is applied to the leads 17a and 17b, the actuator 13a is not driven without being applied with the drive voltage as shown in FIG. 5(b).

Further, the drive control section 20 applies the voltage +VAA to the lead 17c as the auxiliary expansion pulse Dmp. If the voltage +VAA is applied to the lead 17c, the actuator 13b is applied with the drive voltage of +VAA*2 based on the electrode 16b. As shown in FIG. 5(b), the actuator 13b to which the drive voltage of +VAA*2 is applied is driven to be bent to the outer side of the pressure chamber 18b as shown in FIG. 5(b).

The drive control section 20 may output the auxiliary expansion pulse Dmp, the ejection pulse and the auxiliary contraction pulse Bst to the leads 17a to 17c in order. Further, the drive control section 20 may output either the auxiliary expansion pulse Dmp or the auxiliary contraction pulse Bst to the leads 17a to 17c. Further, the drive control section 20 may output the auxiliary pulse to the leads 17a to 17c in a case in which the ink is not ejected from the pressure chamber 18b (in a case in which a drive pulse is not output).

The inkjet head constituted as stated above outputs the drive voltage to one of two actuators which form the pressure chamber as the auxiliary pulse. Thus, the inkjet head drives the one actuator in a direction in which the pressure chamber is expanded or contracted. Therefore, the inkjet head generates the volume change in the pressure chamber which is smaller than the volume change generated at the time of the ejection. As a result, the inkjet head can adjust the pressure vibration in the ink chamber in more detail.

### Second Embodiment

Next, the second embodiment is described.

The inkjet printer 1 according to the second embodiment is different from the first embodiment in that the drive control section 20 outputs the auxiliary pulse for driving the actuators 13a and 13b. Therefore, as to other points, the same reference numerals are denoted, and the detailed description is omitted.

Firstly, the auxiliary pulse according to the second embodiment is described. The auxiliary pulse generates a drive amount which is smaller than a drive amount of the actuators 13a and 13b generated by the expansion pulse or the contraction pulse. For example, the auxiliary pulse has a drive voltage which is half of a drive voltage of the expansion pulse or the contraction pulse. In other words, the drive control section 20 outputs the drive voltage which is half of the drive voltage of the expansion pulse or the contraction pulse to the actuators 13a and 13b as the auxiliary pulse.

For example, the auxiliary expansion pulse Dmp has a drive voltage which is half of a drive voltage of the expansion pulse D.

For example, the drive control section 20 applies the voltage +VAA to the lead 17a and the lead 17c, and sets the lead 17b to the GND. The actuator 13a in a state in which the voltage +VAA is applied to the lead 17a and the lead 17b becomes the GND is applied with the voltage +VAA based on the electrode 16b. The actuator 13a to which the voltage +VAA is applied is driven by half of the drive amount of the expansion pulse D to the outer side (in a direction in which the volume of the pressure chamber 18b is expanded).

The actuator 13b in a state in which the voltage +VAA is applied to the lead 17c and the lead 17b becomes the GND is applied with the voltage +VAA based on the electrode 16b. The actuator 13b to which the voltage +VAA is applied is driven by half of the drive amount of the expansion pulse D to the outer side (in a direction in which the volume of the pressure chamber 18b is expanded). In other words, if the voltage +VAA is applied to the leads 17a and 17c and the lead 17b becomes the GND, the volume of the pressure chamber 18b is increased by about 50% of the increase of the volume generated by the expansion pulse D.

Further, the auxiliary contraction pulse Bst has a drive voltage which is half of a drive voltage of the contraction pulse P.

Further, the drive control section 20 applies the voltage −VAA to the lead 17a and the lead 17c, and sets the lead 17b to the GND. The actuator 13a in a state in which the voltage −VAA is applied to the lead 17a and the lead 17b becomes the GND is applied with the voltage −VAA based on the electrode 16b. The actuator 13a to which the voltage −VAA is applied is driven by half of the drive amount of the contraction pulse P to the inner side (in a direction in which the volume of the pressure chamber 18b is contracted).

The actuator 13b in a state in which the voltage −VAA is applied to the lead 17c and the lead 17b becomes the GND is applied with the voltage −VAA based on the electrode 16b. The actuator 13b to which the voltage −VAA is applied is driven by half of the drive amount of the contraction pulse P to the inner side (in a direction in which the volume of the pressure chamber 18b is contracted). In other words, if the voltage −VAA is applied to the leads 17a and 17c and the lead 17b becomes the GND, the volume of the pressure chamber 18b is decreased by about 50% of the decrease of the volume generated by the contraction pulse P.

Next, the drive voltages which are applied to the leads 17a to 17c by the drive control section 20 are described.

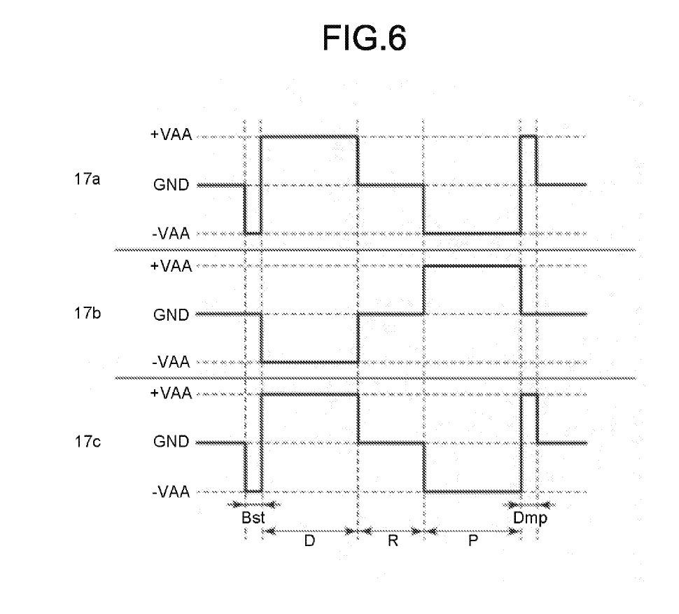

FIG. 6 is a timing chart illustrating the drive voltages which are applied to the leads 17a to 17c by the drive control section 20.

The drive control section 20 applies the voltage −VAA to the lead 17a as the auxiliary contraction pulse Bst. Further, the drive control section 20 applies the voltage +VAA as the auxiliary expansion pulse Dmp if outputting the contraction pulse P.

Further, the drive control section 20 sets the lead 17b to the GND as the auxiliary contraction pulse Bst. Further, the drive control section 20 sets the lead 17b to the GND as the auxiliary expansion pulse Dmp if outputting the contraction pulse P.

Further, the drive control section 20 applies the voltage −VAA to the lead 17c as the auxiliary contraction pulse Bst. Further, the drive control section 20 applies the voltage +VAA as the auxiliary expansion pulse Dmp if outputting the contraction pulse P.

Next, an example of operations of the actuators 13a and 13b is described.

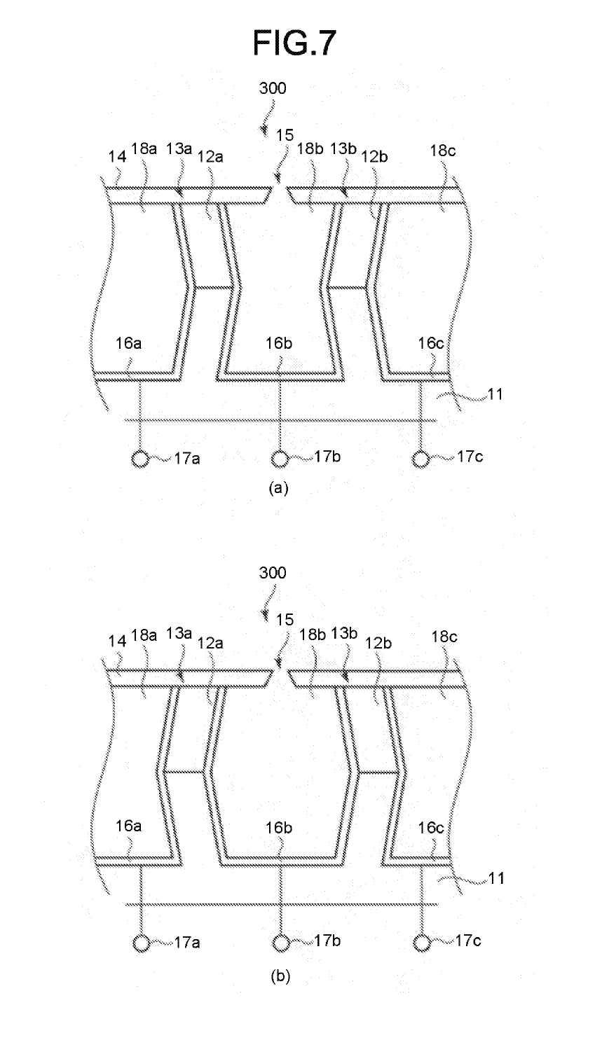

FIG. 7 is a diagram illustrating an example of the operations of the actuators 13a and 13b while the drive control section 20 outputs the auxiliary pulse. FIG. 7(a) illustrates an example of the operations while the drive control section 20 outputs the auxiliary contraction pulse Bst. Further, FIG. 7(b) illustrates an example of the operations while the drive control section 20 outputs the auxiliary expansion pulse Dmp.

The drive control section 20 applies the voltage −VAA to the lead 17a as the auxiliary contraction pulse Bst. Further, the drive control section 20 sets the lead 17b to the GND. If the voltage −VAA is applied to the lead 17a, and the lead 17b becomes the GND, the actuator 13a is applied with the voltage −VAA based on the electrode 16b. As shown in FIG. 7(a), the actuator 13a to which the voltage −VAA is applied as the auxiliary contraction pulse Bst is driven to be bent to the inner side of the pressure chamber 18b. Further, as shown in FIG. 7(a), the actuator 13a is driven by about half of the drive amount generated by the contraction pulse P.

Further, the drive control section 20 applies the voltage −VAA to the lead 17c as the auxiliary contraction pulse Bst. If the voltage −VAA is applied to the lead 17c, the voltage −VAA is applied to the actuator 13b based on the electrode 16b. As shown in FIG. 7(a), the actuator 13b in a state in which the voltage −VAA is applied to the lead 17c as the auxiliary contraction pulse Bst is driven to be bent to the inner side of the pressure chamber 18b. Further, as shown in FIG. 7(a), the actuator 13a is driven by about half of the drive amount generated by the contraction pulse P.

Further, the drive control section 20 applies the voltage +VAA to the lead 17a as the auxiliary expansion pulse Dmp. Further, the drive control section 20 sets the lead 17b to the GND. If the voltage +VAA is applied to the lead 17a and the lead 17b becomes the GND, the voltage +VAA is applied to the actuator 13a based on the electrode 16b. As shown in FIG. 7(b), the actuator 13a to which the voltage +VAA is applied is driven to be bent to the outer side of the pressure chamber 18b. Further, as shown in FIG. 7(b), the actuator 13a is driven by about half of the drive amount generated by the expansion pulse D.

Further, the drive control section 20 applies the voltage +VAA to the lead 17c as the auxiliary expansion pulse Dmp. If the voltage +VAA is applied to the lead 17c, the voltage +VAA is applied to the actuator 13b based on the electrode 16b. As shown in FIG. 7(b), the actuator 13b in a state in which the voltage +VAA is applied to the lead 17c as the auxiliary expansion pulse Dmp is driven to be bent to the outer side of the pressure chamber 18b. Further, as shown in FIG. 7(b), the actuator 13b is driven by about half of the drive amount generated by the expansion pulse D.

Furthermore, the drive control section 20 may set the lead 17a and the lead 17c as the GND and apply the voltage +VAA to the lead 17b as the auxiliary contraction pulse Bst. Further, the drive control section 20 may set the lead 17a and the lead 17c as the GND and apply the voltage −VAA to the lead 17b as the auxiliary expansion pulse Dmp.

The inkjet head constituted as stated above applies the drive voltage which is half of the drive voltage at the time of the ejection to the actuator. Thus, the drive amount of the actuator is about half of the drive amount at the time of the ejection. Therefore, the inkjet head generates the volume change in the pressure chamber which is smaller than the volume change at the time of the ejection. As a result, the inkjet head can adjust the pressure vibration in the ink chamber in more detail.

### Third Embodiment

Next, the third embodiment is described.

The inkjet printer 1 according to the third embodiment is different from the first embodiment in that the drive control section 20 outputs the auxiliary pulse for driving one of the actuators 13a and 13b by the drive amount which is half of the drive amount at the time of the ejection. Therefore, as to other points, the same reference numerals are denoted, and the detailed description is omitted.

Firstly, the auxiliary pulse according to the third embodiment is described.

The auxiliary pulse generates a drive amount in either the actuator 13a or the actuator 13b which is smaller than a drive amount of the actuators 13a and 13b generated by the expansion pulse or the contraction pulse. Herein, the auxiliary pulse drives the actuator 13b but not the actuator 13a. For example, the auxiliary pulse has a drive voltage which is half of a drive voltage of the expansion pulse or the contraction pulse.

The auxiliary expansion pulse Dmp generates a change amount in the pressure chamber 18 which is smaller than a change amount of expansion of the volume of the pressure chamber 18 due to the expansion pulse. For example, the auxiliary expansion pulse Dmp generates a change amount which is about 25% of a change amount generated due to the expansion pulse.

For example, the auxiliary expansion pulse Dmp drives one actuator 13 in a direction in which the volume of the pressure chamber 18 is expanded. For example, the drive control section 20 applies the drive voltage to the actuator 13b without applying the drive voltage to the actuator 13a as the auxiliary expansion pulse Dmp. Further, the auxiliary expansion pulse Dmp has a drive voltage which is half of a drive voltage of the expansion pulse D.

For example, the drive control section 20 sets the lead 17a and the lead 17b to the GND, and applies the voltage +VAA to the lead 17c. The actuator 13a in a state in which the leads 17a and 17b become the GND is not driven without being applied with the voltage.

The actuator 13b in a state in which the lead 17b becomes the GND and the voltage +VAA is applied to the lead 17c is applied with the voltage +VAA based on the electrode 16b. The actuator 13b to which the voltage +VAA is applied is driven by half of the drive amount of the expansion pulse D to the outer side (in a direction in which the volume of the pressure chamber 18b is expanded). In other words, if the lead 17a and the lead 17b become the GND and the voltage +VAA is applied to the lead 17c, the volume of the pressure chamber 18b is increased by about 25% of the increase of the volume generated by the expansion pulse D.

Further, the auxiliary contraction pulse Bst generates a change amount in the pressure chamber 18 which is smaller than a change amount of the contraction of the volume of the pressure chamber 18 due to the contraction pulse. For example, the auxiliary contraction pulse Bst generates a change amount of about 25% of a change amount generated due to the contraction pulse.

The auxiliary contraction pulse Bst drives the one actuator 13 in a direction in which the volume of the pressure chamber 18 is contracted. For example, the drive control section 20 applies the drive voltage to the actuator 13b without applying the drive voltage to the actuator 13a as the auxiliary contraction pulse Bst. The auxiliary contraction pulse Bst has a drive voltage which is half of a drive voltage of the contraction pulse P.

For example, the drive control section 20 applies the voltage +VAA to the lead 17a and the lead 17b and sets the lead 17c to the GND. The actuator 13a in a state in which the voltage +VAA is applied to the leads 17a and 17b and the lead 17c becomes the GND is not driven without being applied with the voltage.

The actuator 13b in a state in which the voltage +VAA is applied to the lead 17b and the lead 17c becomes the GND is applied with the voltage −VAA based on the electrode 16b. The actuator 13b to which the voltage −VAA is applied is driven by half of the drive amount of the contraction pulse P to the inner side (in a direction in which the volume of the pressure chamber 18b is contracted). In other words, if the voltage +VAA is applied to the leads 17a and 17b and the lead 17c becomes the GND, the volume of the pressure chamber 18b is decreased by about 25% of the decrease of the volume generated by the contraction pulse P.

Next, the drive voltages which are applied to the leads 17a to 17c by the drive control section 20 are described.

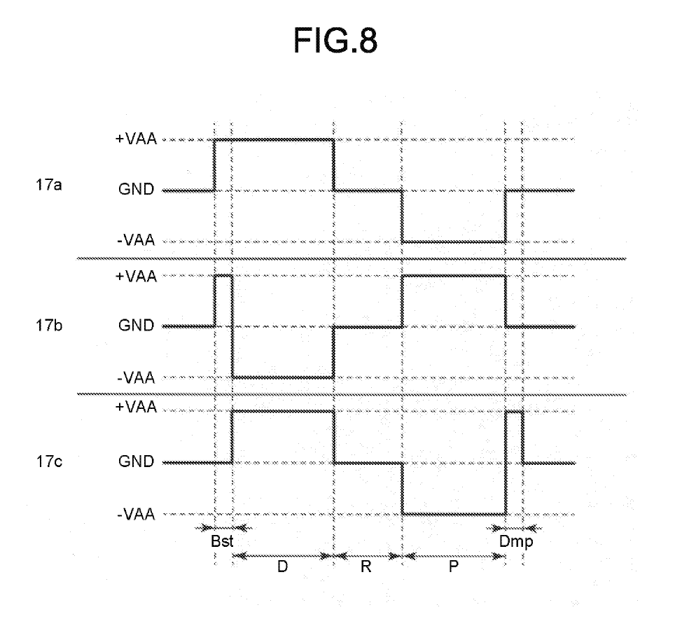

FIG. 8 is a timing chart illustrating the drive voltages which are applied to the leads 17a to 17c by the drive control section 20.

The drive control section 20 applies the voltage +VAA to the lead 17a as the auxiliary contraction pulse Bst. Further, the drive control section 20 sets the lead 17a to the GND as the auxiliary expansion pulse Dmp if outputting the contraction pulse P.

Further, the drive control section 20 applies the voltage +VAA to the lead 17b as the auxiliary contraction pulse Bst. Further, the drive control section 20 sets the lead 17b to the GND as the auxiliary expansion pulse Dmp if outputting the contraction pulse P.

Further, the drive control section 20 sets the lead 17c to the GND as the auxiliary contraction pulse Bst. Further, the drive control section 20 applies the voltage +VAA as the auxiliary expansion pulse Dmp if outputting the contraction pulse P.

Next, an example of operations of the actuators 13a and 13b is described.

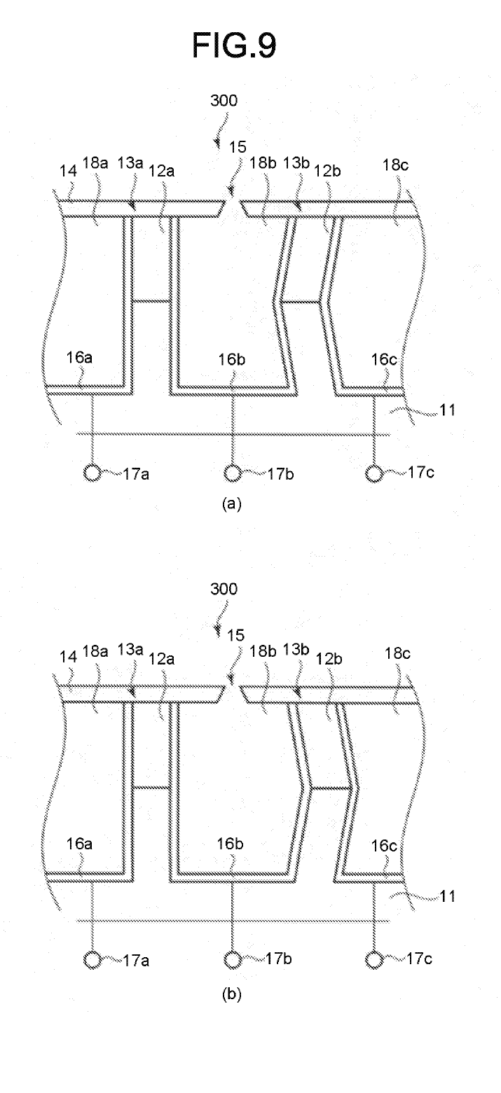

FIG. 9 is a diagram illustrating an example of the operations of the actuators 13a and 13b while the drive control section 20 outputs the auxiliary pulse. FIG. 9(a) illustrates an example of the operations while the drive control section 20 outputs the auxiliary contraction pulse Bst. Further, FIG. 9(b) illustrates an example of the operations while the drive control section 20 outputs the auxiliary expansion pulse Dmp.

The drive control section 20 applies the voltage +VAA to the leads 17a and 17b as the auxiliary contraction pulse Bst. If the voltage +VAA is applied to the leads 17a and 17b, the actuator 13a is not applied with the drive voltage. As a result, as shown in FIG. 9, the actuator 13a is not driven.

Further, the drive control section 20 sets the lead 17c to the GND as the auxiliary contraction pulse Bst. If the lead 17c becomes the GND, the voltage −VAA is applied to the actuator 13b based on the electrode 16b. As a result, as shown in FIG. 9(a), the actuator 13b is driven to be bent to the inner side of the pressure chamber 18b. Further, as shown in FIG. 9(a), the actuator 13b is driven by about half of the drive amount generated by the contraction pulse P.

Further, the drive control section 20 sets the leads 17a and 17b to the GND as the auxiliary expansion pulse Dmp. If the leads 17a and 17b become the GND, the drive voltage is not applied to the actuator 13a. In other words, as shown in FIG. 9(b), the actuator 13a in a state in which the leads 17a and 17b become the GND as the auxiliary expansion pulse Dmp is not driven.

Further, the drive control section 20 applies the voltage +VAA to the lead 17c as the auxiliary expansion pulse Dmp. If the voltage +VAA is applied to the lead 17c, the voltage +VAA is applied to the actuator 13b based on the electrode 16b. As shown in FIG. 9(b), the actuator 13b in a state in which the voltage +VAA is applied to the lead 17c as the auxiliary expansion pulse Dmp is driven to be bent to the outer side of the pressure chamber 18b. Further, as shown in FIG. 9(b), the actuator 13b is driven by about half of the drive amount generated by the expansion pulse D.

The drive control section 20 may set the lead 17a and the lead 17b to the GND and apply the voltage −VAA to the lead 17c as the auxiliary contraction pulse Bst. Further, the drive control section 20 may apply the voltage −VAA to the lead 17a and the lead 17b and set the lead 17c to the GND as the auxiliary expansion pulse Dmp.

The inkjet head constituted as stated above applies the drive voltage which is half of the drive voltage at the time of the ejection to one actuator as the auxiliary pulse. If the drive voltage which is half of the drive voltage at the time of the ejection is applied to one actuator as the auxiliary pulse, the drive amount of the actuator is about ¼ of the drive amount at the time of the ejection. According to the foregoing configuration, the inkjet head can adjust the pressure vibration in the ink chamber in more detail.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An inkjet head, comprising:
a first actuator and a second actuator configured to constitute a pressure chamber;
a first electrode configured to contact the first actuator from an outer side of the pressure chamber;
a second electrode configured to contact the first actuator and the second actuator from an inner side of the pressure chamber;
a third electrode configured to contact the second actuator from the outer side of the pressure chamber; and
a drive controller configured to output an auxiliary pulse which generates a volume change in the pressure chamber that is smaller than a volume change of the pressure chamber generated by an ejection pulse for ejecting ink from the pressure chamber to the first electrode, the second electrode, and the third electrode.

2. The inkjet head according to claim 1, wherein
the drive controller applies a first drive voltage to the first electrode and the second electrode, and outputs a second drive voltage obtained by reversing the first drive voltage to the third electrode as the auxiliary pulse.

3. The inkjet head according to claim 1, wherein
the drive controller applies a drive voltage to the first electrode and the third electrode, and sets the second electrode to a GND as the auxiliary pulse.

4. The inkjet head according to claim 1, wherein
the drive controller applies a drive voltage to the first electrode and the second electrode and sets the third electrode to a GND.

5. The inkjet head according to claim 1, wherein
the drive controller sets the first electrode and the second electrode as a GND and applies a drive voltage to the third electrode as the auxiliary pulse.

6. The inkjet head according to claim 1, wherein the first actuator and the second actuator comprise a piezoelectric element.

7. The inkjet head according to claim 1, wherein the drive controller is configured to output an auxiliary pulse which generates a volume change in the pressure chamber that is 50% or more smaller than a volume change of the pressure chamber generated by an ejection pulse for ejecting ink from the pressure chamber.

8. An inkjet printer, comprising:
a conveyance section configured to convey a medium; and
an inkjet head, the inkjet head comprising:
a first actuator and a second actuator configured to constitute a pressure chamber;
a first electrode configured to contact the first actuator from an outer side of the pressure chamber;
a second electrode configured to contact the first actuator and the second actuator from an inner side of the pressure chamber;
a third electrode configured to contact the second actuator from the outer side of the pressure chamber; and
a drive controller configured to output an auxiliary pulse which generates a volume change in the pressure chamber that is smaller than a volume change of the pressure chamber generated by an ejection pulse for ejecting ink from the pressure chamber to the first electrode, the second electrode, and the third electrode.

9. The inkjet printer according to claim 8, wherein
the drive controller applies a first drive voltage to the first electrode and the second electrode, and outputs a second drive voltage obtained by reversing the first drive voltage to the third electrode as the auxiliary pulse.

10. The inkjet printer according to claim 8, wherein
the drive controller applies a drive voltage to the first electrode and the third electrode, and sets the second electrode to a GND as the auxiliary pulse.

11. The inkjet printer according to claim 8, wherein
the drive controller applies a drive voltage to the first electrode and the second electrode, and sets the third electrode to a GND.

12. The inkjet printer according to claim 8, wherein
the drive controller sets the first electrode and the second electrode as a GND, and applies a drive voltage to the third electrode as the auxiliary pulse.

13. The inkjet printer according to claim 8, wherein the first actuator and the second actuator comprise a piezoelectric element.

14. The inkjet printer according to claim 8, wherein the drive controller is configured to output an auxiliary pulse which generates a volume change in the pressure chamber that is 50% or more smaller than a volume change of the pressure chamber generated by an ejection pulse for ejecting ink from the pressure chamber.

15. An inkjet printing method, comprising:
contacting a first actuator from an outer side of a pressure chamber;
contacting the first actuator and a second actuator from an inner side of the pressure chamber;
contacting the second actuator from the outer side of the pressure chamber; and
outputting an auxiliary pulse which generates a volume change in the pressure chamber that is smaller than a volume change of the pressure chamber generated by an ejection pulse for ejecting ink from the pressure chamber to a first electrode, a second electrode, and a third electrode.

16. The inkjet printing method according to claim 15, wherein
outputting comprises applying a first drive voltage to the first electrode and the second electrode, and outputting a second drive voltage obtained by reversing the first drive voltage to the third electrode as the auxiliary pulse.

17. The inkjet printing method according to claim 15, wherein
outputting comprises applying a drive voltage to the first electrode and the third electrode, and setting the second electrode to a GND as the auxiliary pulse.

18. The inkjet printing method according to claim 15, wherein
outputting comprises applying a drive voltage to the first electrode and the second electrode, and setting the third electrode to a GND.

19. The inkjet printing method according to claim 15, wherein
outputting comprises setting the first electrode and the second electrode as a GND, and applying a drive voltage to the third electrode as the auxiliary pulse.

20. The inkjet printing method according to claim 15, wherein
outputting comprises outputting an auxiliary pulse which generates a volume change in the pressure chamber that is 50% or more smaller than a volume change of the pressure chamber generated by an ejection pulse for ejecting ink from the pressure chamber.
